(19) United States
(12) Patent Application Publication
(10) Pub. No.: US 2003/0188062 A1
(43) Pub. Date: Oct. 2, 2003

(54) Device resource allocation

(76) Inventors: Paul E. Luse, Chandler, AZ (US); Dieter E. Massa, Nedarsulm (DE); Norbert Lewalski-Brechter, Necharsulm (DE)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/113,458

(22) Filed: Mar. 28, 2002

(51) Int. Cl. G06F 13/00

(52) U.S. Cl. 710/104

(57) ABSTRACT

In one embodiment, a method is provided. The method of this embodiment may include the allocating of a first set of resources to a first device, and the allocating, by the first device, of a second set of resources to a second device. The first set of resources may include the second set of resources. If the first set of resources is changed, the method of this embodiment may also including the changing, by the first device, of the second set of resources. Of course, many modifications, variations, and alternatives are possible without departing from this embodiment.

### FIELD

This disclosure relates to the field of device resource allocation.

### BACKGROUND

In modular redundant array of independent or inexpensive disk (RAID) on motherboard (MROMB) techniques, MROMB circuitry residing on a circuit card, for example, may be used to configure and control, independently of a host processor residing on the motherboard, an input/output (I/O) controller that also may reside on the motherboard. MROMB hardware on the motherboard performs operations that enable the MROMB circuitry on the circuit card to configure and control the I/O controller independently of the host processor.

Heretofore, predetermined addresses have been allocated by the circuit card, independently of the host processor, to the I/O controller. As a result, depending upon the addresses that may be allocated to other devices by the host processor, such as, for example, during a host processor-initiated configuration cycle, it may be possible for one or more of the I/O controller's addresses to conflict with one or more of the addresses allocated to such other devices by the host processor.

### BRIEF DESCRIPTION OF THE DRAWINGS

Features and advantages of embodiments of the claimed subject matter will become apparent as the following Detailed Description proceeds, and upon reference to the Drawings, wherein like numerals depict like parts, and in which:

FIG. 1 is diagram that illustrates an embodiment of the claimed subject matter.

FIG. 2 is a diagram that illustrates MROMB motherboard hardware in greater detail.

FIG. 3 is a flowchart that illustrates operations involved in one embodiment of the claimed subject matter.

FIG. 4 is a diagram that illustrates an address allocation in accordance with one embodiment of the claimed subject matter.

FIG. 5 is a flowchart that illustrates operations involved in one mode of operation in accordance with an embodiment of the claimed subject matter.

It should be understood that although the following Detailed Description will proceed with reference being made to illustrative embodiments of the claimed subject matter, many alternatives, modifications, and variations thereof will be apparent to those skilled in the art. Accordingly, it is intended that the claimed subject matter be viewed broadly, and be defined only as set forth in the accompanying claims.

### DETAILED DESCRIPTION

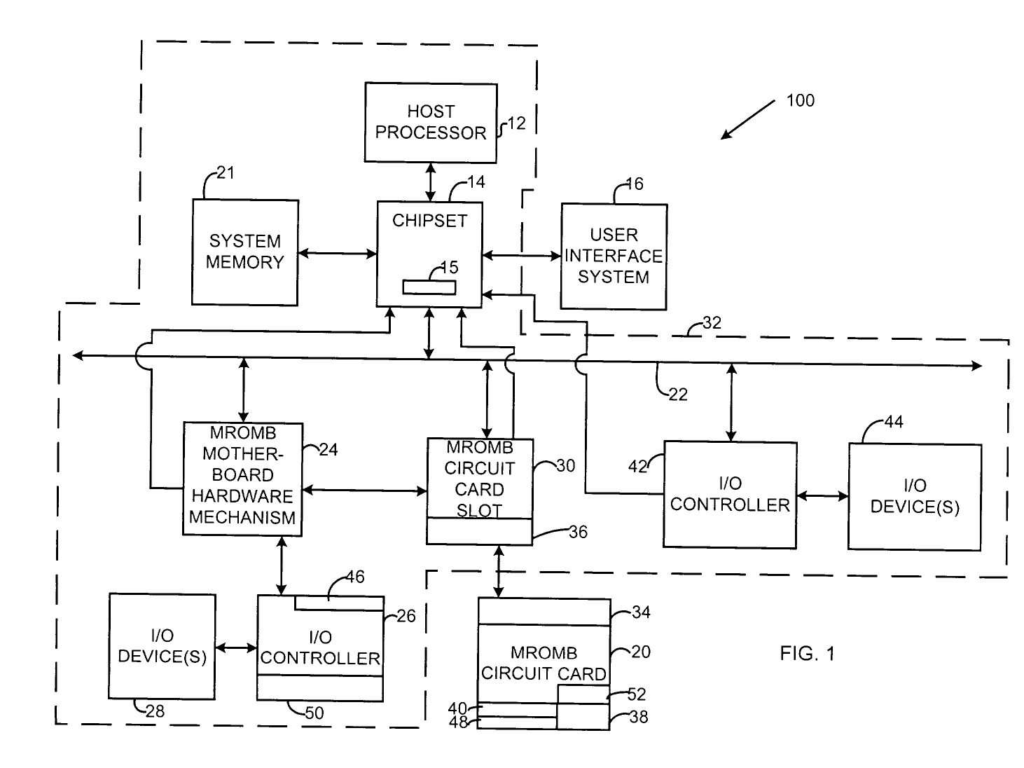

FIG. 1 illustrates a system embodiment 10 of the claimed subject matter. System 10 may include a host processor 12 coupled to a chipset 14. Host processor 12 may comprise, for example, an Intel® Pentium® III or IV microprocessor that is commercially available from the assignee of the subject application. Of course, alternatively, host processor 12 may comprise another type of microprocessor, such as, for example, a microprocessor that is manufactured and/or commercially available from a source other than the assignee of the subject application, without departing from this embodiment.

Chipset 14 may comprise a host bridge/hub system that may couple host processor 12, a system memory 21 and a user interface system 16 to each other and to a bus system 22. Chipset 14 may also include an I/O bridge/hub system (not shown) that may couple the host bridge/bus system to bus 22. Chipset 14 may comprise integrated circuit chips, such as those selected from integrated circuit chipsets commercially available from the assignee of the subject application (e.g., graphics memory and I/O controller hub chipsets), although other integrated circuit chips may also, or alternatively be used, without departing from this embodiment. Additionally, chipset 14 may include an interrupt controller 15 that may process interrupts that it may receive from other components in system 100, such as, e.g., MROMB circuit card 20, when card 20 is properly inserted into circuit card bus extension slot 30, I/O controller 26, and I/O controller 42. Of course, alternatively, the operative MROMB circuitry described herein as being comprised in card 20, need not be comprised in card 20, but instead, without departing from this embodiment, may be comprised in other structures, systems, and/or devices that may be coupled to bus 22, and exchange data and/or commands with other components in system 100. User interface system 16 may comprise, e.g., a keyboard, pointing device, and display system that may permit a human user to input commands to, and monitor the operation of, system 100.

Bus 22 may comprise a bus that complies with the Peripheral Component Interconnect (PCI) Local Bus Specification, Revision 2.2, Jun. 8, 1998 available from the PCI Special Interest Group, Portland, Oreg., U.S.A. (hereinafter referred to as a “PCI bus”). Alternatively, if system 100 is appropriately modified, bus 22 instead may comprise a bus that complies with the PCI-X Specification Rev. 1.0a, published by and available from the aforesaid PCI Special Interest Group, Portland, Oregon, U.S.A. (hereinafter referred to as a “PCI-X bus”). It should be appreciated, however, that if system 100 is appropriately modified, bus 22 may comprise other types and configurations of bus systems, without departing from this embodiment.

An I/O controller 26 may be coupled, via MROMB motherboard hardware mechanism 24, to chipset 14, PCI bus 22, and MROMB circuit card slot 30. I/O controller 26 may also be coupled to and control the operation of one or more I/O devices (hereinafter collectively or singly referred to as “I/O device 28”). I/O device 28 may comprise, for example, a set of one or more storage devices comprising, e.g., one or more magnetic disks, optical disks, or solid-state storage devices. The one or more storage devices may be configured as e.g., one or more arrays of mass storage devices.

Alternatively, I/O device 28, instead, may comprise one or more network adapter or interface devices that may be used to interface system 100 to one or more external computer networks. According to this alternative arrangement, I/O device 28 may exchange data and/or commands with external network devices (e.g., host or server computer nodes) via the one or more external computer networks.

System 100 also may include another I/O controller 42. I/O controller 42 may be coupled to bus 22. I/O controller 42 may also be coupled to and control the operation of one or more I/O devices (hereinafter collectively or singly referred to as “I/O device 44”). I/O device 44 may comprise, for example, a set of one or more storage devices comprising, e.g., one or more magnetic disks, optical disks, or solid-state storage devices. These one or more storage devices may be configured as e.g., one or more arrays of mass storage devices.

Alternatively, I/O device 44, instead, may comprise one or more network adapter or interface devices that may be used to interface system 100 to one or more external computer networks. According to this alternative arrangement, I/O device 44 may exchange data and/or commands with external network devices (e.g., host or server computer nodes) via the one or more external computer networks.

Processor 12, system memory 21, chipset 14, PCI bus 22, MROMB hardware mechanism 24, MROMB circuit card slot 30, I/O controller 26, and I/O controller 42 may be comprised in a single circuit board, such as, for example, a system motherboard 32. Although I/O device 28 and I/O device 44 arc shown in FIG. 1 as being comprised in the motherboard 32, I/O device 28 and/or I/O device 44 need not be comprised in the motherboard 32. For example, I/O device 28 and I/O device 44 each may be comprised in one or more respective enclosures that are separate from the enclosure in which the motherboard 32 and the components comprised in the motherboard 32 are enclosed.

Depending upon the particular configuration and operational characteristics of I/O device 28, I/O controller 26 may exchange data and/or commands with I/O device 28 using any one of a variety of different communication protocols, e.g., a Small Computer Systems Interface (SCSI), Fibre Channel (FC), Ethernet, Serial Advanced Technology Attachment (S-ATA), or Transmission Control Protocol/Internet Protocol (TCP/IP) communication protocol. Of course, alternatively, I/O controller 26 may exchange data and/or commands with I/O device 28 using other communication protocols, without departing from this embodiment of the claimed subject matter.

In accordance with this embodiment, a SCSI protocol that may be used by controller 26 to exchange data and/or commands with I/O device 28 may comply or be compatible with the interface/protocol described in American National Standards Institute (ANSI) Small Computer Systems Interface-2 (SCSI-2) ANSI X3.131-1994 Specification. If a FC protocol is used by controller 26 to exchange data and/or commands with I/O device 28, it may comply or be compatible with the interface/protocol described in ANSI Standard Fibre Channel (FC) Physical and Signaling Interface-3 X3.303:1998 Specification. Alternatively, if an Ethernet protocol is used by controller 26 to exchange data and/or commands with I/O device 28, it may comply or be compatible with the protocol described in Institute of Electrical and Electronics Engineers, Inc. (IEEE) Std. 802.3, 2000 Edition, published on Oct. 20, 2000. Further, alternatively, if a S-ATA protocol is used by controller 26 to exchange data and/or commands with I/O device 28, it may comply or be compatible with the protocol described in “Serial ATA: High Speed Serialized AT Attachment,” Revision 1.0, published on Aug. 29, 2001 by the Serial ATA Working Group. Also, alternatively, if TCP/IP is used by controller 26 to exchange data and/or commands with I/O device 28, it may comply or be compatible with the protocols described in Internet Engineering Task Force (IETF) Request For Comments (RFC) 791 and 793, published September 1981. Also in accordance with this embodiment, I/O device 28 is used to interface system 100 to one or more external computer networks, I/O device 28 may exchange data and/or commands with external host and/or server computer nodes via the one or more external computer networks using, e.g., the aforesaid TCP/IP and/or Ethernet protocols.

Similarly, depending upon the particular configuration and operational characteristics of I/O device 44, I/O controller 42 may exchange data and/or commands with I/O device 44 using one of the different types of communication protocols that may be used by I/O controller 26 (depending upon the particular configuration and operational characteristics of I/O device 28) to exchange data and/or commands with I/O device 28. Alternatively, I/O controller 42 may exchange data and/or commands with I/O device 44 using other communication protocols, without departing from this embodiment of the claimed subject matter.

Circuit card slot 30 may comprise a PCI expansion slot that comprises a PCI bus connector 36. Connector 36 may be electrically and mechanically mated with a PCI bus connector 34 that is comprised in MROMB circuit card 20. In addition to comprising connector 34, circuit card 20 also may comprise an I/O processor 40 and computer-readable memory 38. Depending upon the particular embodiment, memory 38 may comprise one or more of the following types of computer-readable memories: semiconductor firmware memory, programmable memory, non-volatile memory, read only memory, electrically programmable memory, random access memory, cache memory, flash memory, magnetic disk memory, and/or optical disk memory. Additionally, it should be appreciated that, either additionally or alternatively, memory 38 may comprise other and/or later-developed types of computer-readable memory. Processor 40 may include integrated circuit chips (not shown) comprised in an integrated circuit chipset, such as those commercially available from the assignee of the subject application (e.g., the Intel® 80310 Chipset). Alternatively, processor 40 instead may comprise other integrated circuit chips (e.g., the Intel® 80960 RM/RN I/O processor, the Intel® 80321 processor, and/or other types of processors that are available from sources other than the assignee of the subject application), or other types of processors/integrated circuits without departing from this embodiment of the claimed subject matter.

Slot 30 and card 20 are constructed to permit card 20 to be inserted into slot 30. When card 20 is properly inserted into slot 30, connectors 34 and 36 become electrically and mechanically coupled to each other. When connectors 34 and 36 are so coupled to each other, card 20 becomes electrically coupled, via motherboard MROMB hardware mechanism 24, to controller 26 and to interrupt controller 15, and card 20 also becomes electrically coupled to bus 22.

In this embodiment, MROMB hardware mechanism 24 in motherboard 32 permits a MROMB technique to be implemented in system 100. For example, hardware mechanism 24 may comprise MROMB circuitry of the type used in the Intel® SCB2 Server Board (commercially available from the Assignee of the subject application), which MROMB circuitry may permit a RAID input/output steering (RAIDIOS) technique to be implemented in system 100. Alternatively, hardware mechanism 24 may comprise embedded RAID logic (EMRL) MROMB circuitry of the type used in, e.g., the P3TDDR™ motherboard (commercially available from SUPERMICRO Computer Corporation of San Jose, Calif., United States of America), which MROMB circuitry may permit an EMRL technique to be implemented in system 100. Although hardware 24 will be described herein as implementing either a RAIDIOS or an EMRL technique, alternatively, hardware mechanism 24 may implement other types of MROMB techniques, without departing from this embodiment.

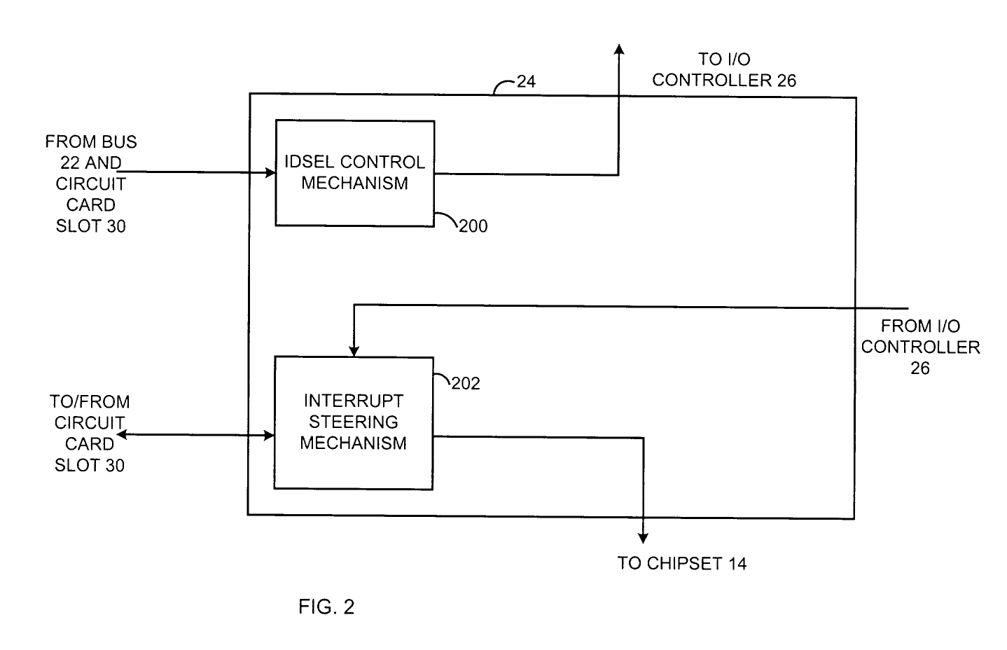

With particular reference now being made to FIG. 2, the particular configuration and operation of hardware mechanism 24 may vary depending upon whether hardware mechanism 24 implements a RAIDIOS or non-RAlDIOS type of MROMB technique (e.g., the EMRL MROMB technique). However, in either case, in this embodiment, the MROMB hardware 24 may comprise an Initialization Device Select (IDSEL) control mechanism 200 and an interrupt steering mechanism 202. IDSEL control mechanism 200 may be coupled to PCI bus 22, circuit card slot 30, and I/O controller 26. IDSEL control mechanism 200 may include circuitry that may controllably couple an IDSEL signal line of I/O controller 26 to, or de-couple that line from PCI bus 22, based at least in part upon a control signal provided from slot 30 to mechanism 200.

As is well known to those skilled in the art, an IDSEL signal line of I/O controller 26 may be coupled to a predetermined one of the address lines of bus 22, and the IDSEL signal that may be supplied to controller 26 via that line may be used during configuration cycles (such as, for example, following a reset of system 100) as a select or enable signal to enable configuration and/or control of the I/O controller during such configuration cycles. In accordance with this embodiment, when card 20 is absent from slot 30, a control signal is supplied to mechanism 200 from slot 30 that results in mechanism 200 coupling this IDSEL signal line to bus 22 in order to allow host processor 12 to drive that line during host processor-initiated configuration cycles. However, when card 20 is properly inserted into slot 30, slot 30 supplies a control signal to mechanism 200 that results in mechanism 200 de-coupling the IDSEL line of controller 26 from bus 22 to “hide” controller 26 from host processor 12 during such cycles. Thereafter, by appropriately controlling this control signal, card 20 may selectively couple I/O controller 26 to, and/or selectively de-couple of I/O controller 26 from bus 22, via the IDSEL line of controller 26, during multiple scans of bus 22 initiated by I/O processor 40, in order to permit controller 26 to be discovered, configured and/or controlled by card 20, instead of by host processor 12. Although not shown in the Figures, with the exception of the one predetermined address line of bus 22 that is used to propagate the IDSEL signal to the I/O controller 26, in this embodiment, the signal lines of PCI bus 22 may be directly coupled to the I/O controller 26 in such a way as to permit I/O controller 26 to exchange data and/or commands, via bus 22, with other devices in system 100 that may also be coupled to bus 22.

Interrupt steering mechanism 202 may be coupled to circuit card slot 30, I/O controller 26, and interrupt controller 15 in chipset 14. Mechanism 202 may selectively couple one or more interrupt signal lines from I/O controller 26 to card slot 30. Mechanism 202 also may selectively couple these one or more interrupt signal lines to interrupt controller 15 in chipset 14 based upon a control signal supplied to mechanism from slot 30. This control signal may result in these one or more interrupt signal lines of I/O controller 26 being coupled to interrupt controller 15 when card 20 is absent from slot 30, and may result in these one or more interrupt signal lines being de-coupled from interrupt controller 15 when card 20 is properly inserted in slot 30. Thus, when card 20 is absent from slot 30, interrupt signals generated by I/O controller 26 may be routed or steered by mechanism 202 to interrupt controller 15 for processing by interrupt controller 15. However, when card 20 is present in slot 30, interrupt signals generated by I/O controller 26 may be routed by mechanism 202 to card 20 for processing by processor 40 in card 20. Slot 30 may transmit interrupt signals generated by card 20, when card 20 is properly inserted into slot 30, to interrupt controller 15 to permit these interrupts to be handled by interrupt controller 15.

If hardware mechanism 24 implements RAIDIOS, IDSEL control mechanism 200 may include a transistor-based switching mechanism (not shown) that may be either in a first state, in which the IDSEL signal line of I/O controller 26 may be coupled to PCI bus 22, or in a second state, in which that signal line may be de-coupled from PCI bus 22. In one embodiment, the control signal that controls the state of this switching mechanism may be the Joint Test Action Group (JTAG) IEEE Standard Test Access Port and Boundary-Scan Architecture Test Mode Select (TMS) signal from PCI bus slot 30. This TMS signal may be compliant with IEEE Standard 1149.1 -1990. That is, the TMS signal pin in PCI slot 30 may be coupled to control mechanism 200, and the state of the signal (hereinafter termed the “TMS signal” of slot 30) propagating to control mechanism 200 through this TMS signal pin of slot 30 may control the state of the switching mechanism in control mechanism 200. Slot 30 may be constructed such that, when card 20 is absent from slot 30, the state of this TMS signal may be driven to a logic state (e.g., a high logic state) that may result in the switching mechanism in control mechanism 200 connecting to bus 22 the IDSEL signal line of controller 26. However, when card 20 is properly inserted into slot 30, processor 40 of card 20 may control the logic state of this TMS signal. Thereafter, processor 40 may control the logic state of this TMS signal in the manner that will be described below.

Additionally, if hardware 24 implements RAIDIOS, interrupt steering mechanism 202 may include a plurality of tri-state buffers (not shown) controlled by the logic state of the signal (hereinafter termed the “TDI signal” from slot 30) propagating through the JTAG Test Data Input (TDI) pin of slot 30. These tri-state buffers may permit predetermined interrupt signals from controller 26 to be received by interrupt controller 15 when the signal propagating through the TDI pin of slot 30 is of a predetermined logic level (e.g., a high logic state). Slot 30 may be constructed such that, when card 20 is absent from slot 30, the signal propagating through the TDI pin of slot 30 may be driven to a high logic state, and conversely, when card 20 is properly inserted in slot 30, this signal may be driven to a low logic state and the interrupt signals from I/O controller 26 may be routed to predetermined interrupt signal pins of slot 30. An interrupt signal pin of slot 30 may be coupled to interrupt controller 15.

As stated previously, the construction of hardware mechanism 24 may vary depending upon the particular MROMB technique that may be implemented. Thus, if hardware mechanism 24 implements a non-RAIDIOS MROMB technique, the construction and operation of IDSEL control mechanism 200, interrupt steering mechanism 202, and the control signals provided to hardware mechanism 24 from slot 30 may differ from those described for the RAIDIOS technique. Processor 40 may issue control signals that may result in card 20 providing appropriate control signals to hardware mechanism 24 to control hardware mechanism 24 so as to implement such a MROMB technique. In this embodiment, card 20 may issue appropriate control signals to hardware mechanism 24. More specifically, card 20 may include firmware program instructions stored in memory 38 that, when executed by processor 40, may result in card 20 issuing appropriate control signals to hardware 24 to control and/or configure I/O controller 26.

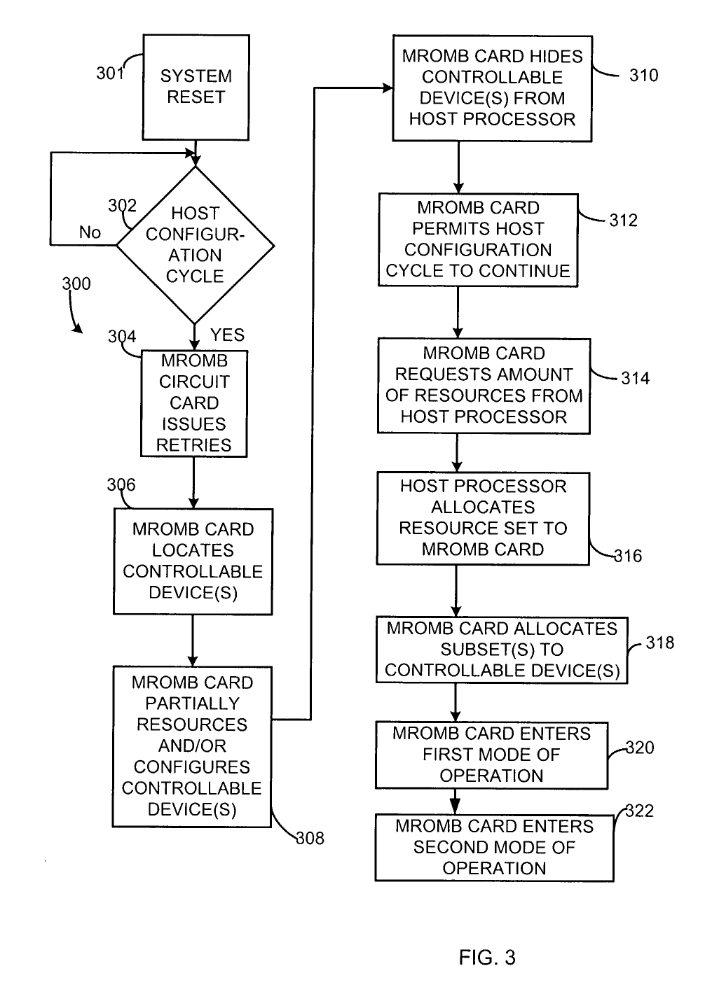

FIG. 3 is a flowchart that illustrates these and other operations 301 that may be carried out in system 100, in accordance with one embodiment. After, for example, a reset of system 100, such as operation 301 in FIG. 3, I/O processor 40 in card 20 may execute one or more subroutines or procedures comprised in the firmware program instructions stored in memory 38. This may result in I/O processor 40 determining, based upon signals propagating through bus 22, whether host processor 12 has initiated configuration cycles for devices (hereinafter termed “bus addressable devices,” e.g., I/O controller 26, I/O controller 42, and card 20) that are coupled to, and are addressable and/or configurable via bus 22 in such configuration cycles, such as operation 302 in FIG. 3. As will be appreciated by those skilled in the art, MROMB motherboard hardware 24 comprises a controllable interface through which interrupt and IDSEL signals of I/O controller 26 may propagate.

After I/O processor 40 has determined that host processor 12 has initiated such configuration cycles, I/O processor 40 may signal card 20. This may result in card 20 issuing retries to host processor 12 to hold-off these configuration cycles initiated by the host processor 12, such as in operation 304 in FIG. 3. Thereafter, while host process-initiated configuration cycles initiated are being held-off, I/O processor 40 may determine any bus addressable devices in system 100 that may be controlled and/or configured by card 20 during one or more configuration cycles initiated by I/O processor 40, using hardware mechanism 200. As used herein, a first device (such as, for example, I/O controller 26) may be considered to be “configurable” by a second device (such as, for example, I/O processor 40), if the second device is capable, at least in part, of controlling and/or selecting at least one feature, mode, and/or characteristic of operation of the first device. I/O processor 40 may also determine the location or locations of any such bus addressable devices may be located, such as, for example, the addresses along bus 22 via which any such bus addressable devices may be configured and/or controlled during one or more configuration cycles initiated by I/O processor 40, using hardware mechanism 24, as is illustrated in operation 306 in FIG. 3. For example, the bus addresses of any such bus addressable devices may be pre-determined, and processor 40 may be programmed with such predetermined locations.

Alternatively, processor 40 may determine the location or locations of any such controllable and/or configurable devices in system 100 based, at least in part, upon results of multiple bus scans, for example, in accordance with the teachings of Paul E. Luse and Dieter E. Massa, U.S. patent application Ser. No. Yet To Be Assigned (Attorney Docket No. 042390.P13491), entitled “DEVICE DISCOVERY AND DYNAMIC CONFIGURATION OF CONTROL APPLICATION,” which Application is assigned to the Assignee of the subject application, and is being filed concurrently with the subject application. As used herein, a “bus scan” involves the issuance of one or more requests (such as, for example, configuration read requests) to one or more addresses of a bus (such as, for example, bus 22) to obtain one or more responses (such as, for example, configuration read responses) that may be, and/or contain information indicative of the existence, characteristics, type, and/or operation of one or more bus addressable devices.

For example, in system 100, I/O controller 26 may be a bus addressable device that may be controllable and/or configurable by processor 40 using hardware 24. Accordingly, as a result of operation 306, processor 40 may determine that I/O controller 26 is such a bus addressable device, and processor 40 may also determine the address along bus 22 via which I/O controller 26 may be controlled and/or configured during one or more configuration cycles initiated by I/O processor 40, using hardware mechanism 24

After processor 40 has completed operation 306, processor 40 may partially resource and/or configure any bus addressable devices that it determines to be controllable and/or configurable by processor 40 using hardware 24, based upon configuration information obtained by processor 40 from such devices, as illustrated in operation 308 in FIG. 3. That is, processor 40 may allocate resources to and/or configure any such bus addressable devices, with the exception that, in operation 308, processor 40 may not make an allocation of memory mapped I/O address resources. As used herein, a “resource” of a system may include a facility, instrumentality, and/or identifier for such facility and/or instrumentality in the system, that may be allocated (e.g., granted) from a pool of facilities, instrumentalities, and/or identifiers, for use by and/or association with one or more devices in the system, such as, for example, in system 100, one or more memory mapped I/O addresses. As is known to those skilled in the art, in a memory mapped I/O addressing scheme, subsets of a system's total address space may be assigned to I/O ports and/or memory locations associated with and/or used by such ports, and these ports and/or memory locations may be accessed by using and/or specifying addresses comprised in the subsets. As used herein, the tern “address space” is defined to be a set of memory locations that may be separately addressed, such as, for example, via signals propagating through address lines of a bus. Also as used herein, the phrases “amount of an address space” and “size of an address space” are defined to be the number of memory locations comprised in an address space.

In this embodiment, in operation 308, processor 40 may obtain configuration information from I/O controller 26 that may identify the particular device type and characteristics of I/O controller 26. The configuration information obtained by processor 40 from I/O controller 26 also may indicate a size of memory mapped I/O address space that when allocated to I/O ports and/or memory locations (illustrated collectively in FIG. 1 by the structure referenced by numeral 46) in controller 26 may permit processor 40 to control and/or monitor operation of the controller 26. Based upon this information, processor 40 then may signal card 20 to supply and store in controller 26 and memory 21 control and/or configuration-related information to permit controller 26 to operate in accordance with enhanced I/O procedures. As a result of the signaling of card 20 by processor 40, card 20 may apply, via bus 22, signals to memory 21 and/or controller 26. The application of such signals may result in the storing of such control and/or configuration-related information in locations in memory 21 that may be pre-selected so as not to conflict with locations in memory 21 that might be selected by host processor 12, such as, during cycles initiated and/or carried out by the host processor 12, for storage of control and configuration-related information for devices configured by host processor 12. If I/O device 28 comprises an array of disk mass storage devices, these I/O procedures may permit I/O controller 26 and the array to be used as a RAID storage controller and/or RAID array, respectively. Alternatively, if I/O device 28 is used to interface system 100 to an external computer network, the I/O procedures may permit I/O controller 26 to be used as a server management controller, and/or may permit controller 26 and device 28 to utilize additional communication protocols.

After processor 40 has carried out operation 308, processor 40 may signal card 20 to apply to hardware 24 a control signal that may result in hardware 24 hiding from host processor 12 any bus addressable devices that are controllable and/or configurable by processor 40 using hardware 24, as is illustrated by operation 310 in FIG. 3. For example, in this embodiment 100, processor 40 may signal card 20 to apply to hardware 24 a control signal that may result in hardware 24 de-coupling the IDSEL line of I/O controller 26 from bus 22. Thereafter, processor 40 may signal card 20 to stop generating retries to hold-up the host processor's configuration cycles, and may permit the host processor's normal boot process to continue unhindered, as illustrated by operation 312 in FIG. 3.

During one of the host processor's configuration cycles, the processor 40 may signal card 20 to request from host processor 12 an amount of resources of system 100 to be allocated to card 20. This may result in card 20 issuing to host processor 12, via bus 22, a request that such an amount of resources be allocated to card 20 by host processor 12, as illustrated by operation 314 in FIG. 3.

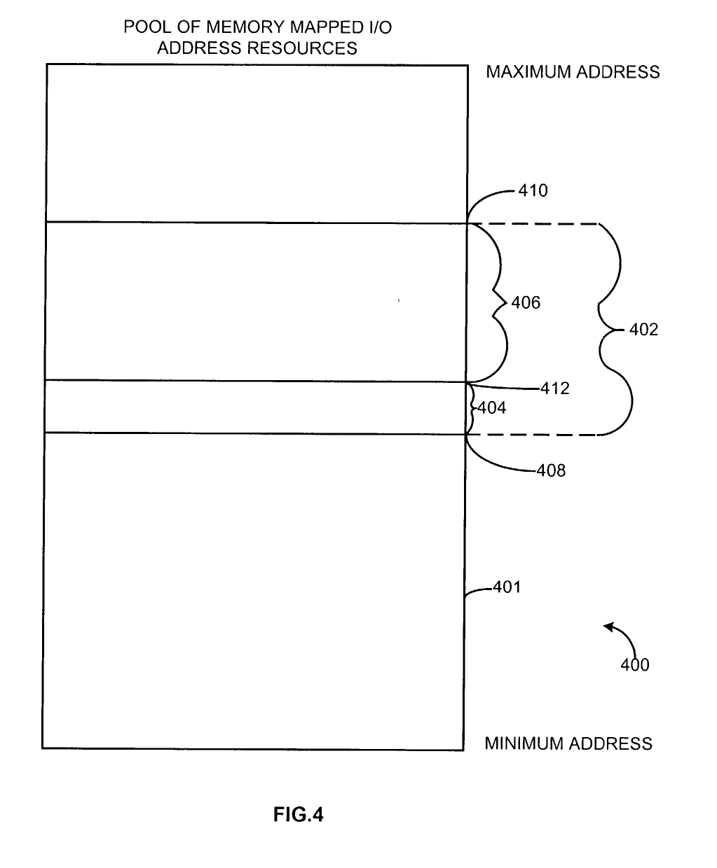

As shown in FIG. 4, system 100 comprises a total amount or available pool memory mapped I/O address resources 400. Resources 400 comprise a plurality of memory mapped I/O addresses 401 that may extend contiguously from a predetermined minimum address to a predetermined maximum address. The resources requested by card 20 may include an amount of memory mapped I/O address space 402. In response to the request from card 20, host processor 12 may allocate to card 20 a set of resources that may include, for example, address space 402, and may signal card 20, via bus 22, that this set of resources has been allocated to card 20, as illustrated in operation 316 in FIG. 3.

Address space 402 may comprise a plurality of contiguous addresses that may extend from a lowest address 408 to a highest address 410 in space 402. The amount of address space 402 requested by card 20 may be calculated by I/O processor 40 by adding together the amounts of two address spaces 404 and 406 that may be comprised address space 402. Address space 404 may extend from the lowest address 408 in space 402 to a higher address 412 in space 402. Address space 406 may extend from a next highest address after address 412 in space 402 to the highest address 410 in space 402. Processor 40 may determine the amount of address space 406, based upon the configuration information obtained by processor 40 from the bus addressable devices, for example, in operation 308 in FIG. 3, that processor 40 determined, for example, in operation 306 in FIG. 3, to be controllable and/or configurable by processor 40 using hardware 24. More specifically, respective configuration information obtained by processor 40 from these bus addressable devices, for example, in operation 308 in FIG. 3, may indicate respective sizes of memory mapped I/O address spaces that when allocated to I/O ports and/or memory locations of these devices may permit processor 40 to control and/or monitor operation of these devices. The amount of address space 406, as determined by processor 40, may be equal to the sum of these respective sizes of the memory mapped I/O address spaces. For example, in system 100, the amount of address space 406, as determined by processor 40, may be equal to the amount of memory mapped I/O address space that may be indicated in the configuration information obtained by processor 40 from controller 26 in operation 308.

Processor 40 may be programmed with the amount of address space 404. The amount of address space 404 may be equal to an amount of memory mapped I/O address space that when allocated to one or more I/O ports and/or memory locations (illustrated collectively in FIG. 1 by the structure referenced by numeral 52) in card 20 may permit one or more other devices in system 100, such as, for example, host processor 12 and/or controller 26, to exchange data and/or commands with card 20.

In accordance with this embodiment, after host processor 12 allocates a set of resources to card 20, I/O processor 40 allocates subsets of that set of resources to card 20 and to the bus addressable devices that processor 40 may control and/or configure using hardware 24. For example, the set of resources allocated to card 20 may include an address space 402. I/O processor 40 may allocate the addresses comprised in the space 404 to I/O ports and/or memory locations 52 in card 20. Processor 40 may also divide space 406 into one or more subsets which may be allocated by processor 40 to the I/O ports and/or memory locations in the bus addressable devices that processor 40 determined to be controllable and/or configurable by processor 40 using hardware 24, as illustrated by operation 318. Processor 40 may store in one or more memory locations 48 in processor 40 one or more values that may specify and/or indicate mappings of the addresses in these respective subsets in space 406 to these I/O ports and/or memory locations in these devices and a mapping of the addresses in space 404 to I/O ports and/or memory locations 52. Processor 40 may transmit, via bus 22, to the bus addressable devices that processor 40 determined to be controllable and/or configurable by processor using hardware 24 the mappings of the addresses in these respective subsets in space 406 to the I/O ports and/or memory locations of these devices. In response, these bus addressable devices may assign memory mapped I/O addresses to their I/O ports and/or memory locations in accordance with these mappings. After processor 40 has transmitted these mappings to these bus addressable devices, processor 40 may signal card 20 to enter a first mode of operation. As a result of this signaling of card 20 by processor 40, card 20 may enter a first mode of operation, as illustrated by operation 320 in FIG. 3. Thereafter, processor 40 may signal card 20 to enter a second mode of operation, and this may result in card 20 entering a second mode of operation, as illustrated by operation 322 in FIG. 3.

For example, in system 100, processor 40 may allocate the addresses in space 406 to I/O ports and/or memory locations 46 in controller 26. Processor 40 may store in one or more memory locations 48 in processor 40 one or more values that may specify and/or indicate a mapping of the addresses in space 406 to I/O ports and/or memory locations 46. Processor 40 may transmit, via bus 22, to controller 26 the mapping of the addresses in space 406 to I/O ports and/or memory locations 46. In response, controller 26 may store in one or more memory locations 50 in controller 26 one or more values that may assign to I/O ports and/or memory locations 46 memory mapped I/O addresses in accordance with the mapping transmitted to controller 26.

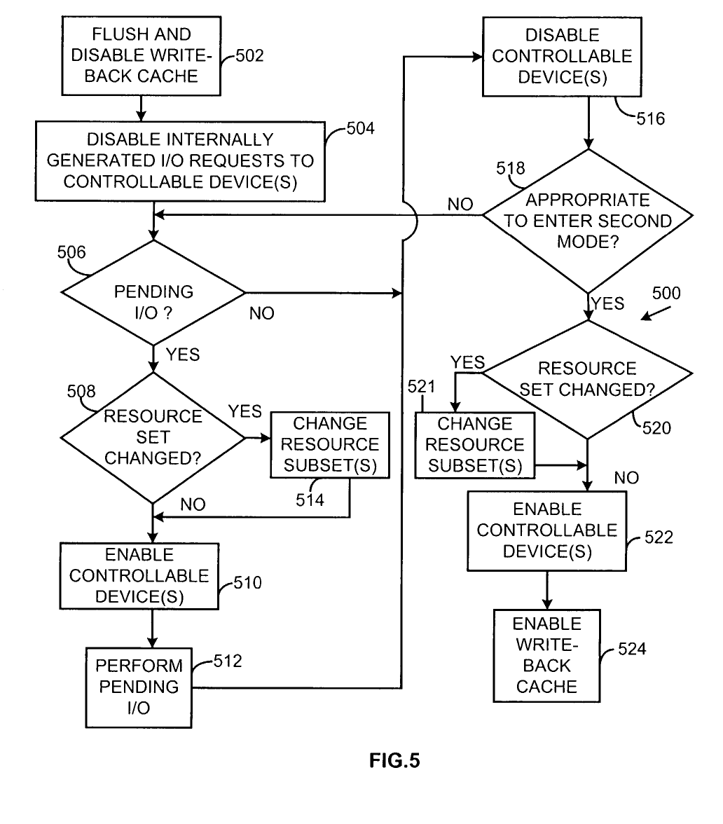

FIG. 5 illustrates operations 500 that may be carried out after card 20 enters the first mode of operation. After card 20 enters the first mode of operation, processor 40 may signal card 20 to flush and disable a write-back cache memory (not shown) comprised in memory 38, as illustrated by operation 502 in FIG. 5. This may result in card 20 flushing (e.g., clearing) this write-back cache memory of one or more I/O transactions to be executed by one or more of the bus addressable devices that processor 40 determined to be controllable and/or configurable by processor using hardware 24. In this embodiment, prior to flushing these I/O transactions from the cache memory, card 20 may store in memory 38 information that may be used by processor 40 to reconstruct later these I/O transactions. Thereafter, card 20 may disable the write-back cache from recording new I/O transactions to be executed by such bus addressable devices. After completing operation 502, processor 40 may disable card 20 from requesting that such bus addressable devices perform “internally generated I/O requests,” as illustrated by operation 504 in FIG. 5. As used herein, an “internally generated I/O request” is an I/O request that does not result from an earlier I/O request provided to card 20 from a device that is external to card 20, such as, for example, host processor 12.

Processor 40 then may determine (e.g., based upon information stored in memory 38 that may track I/O transactions assigned by processor 40 to be performed by one or more of the bus addressable devices that processor 40 determined to be controllable and/or configurable by processor 40 using hardware 24) whether pending I/O transactions have been assigned by processor 40 to be performed by one or more such bus addressable devices, as illustrated in FIG. 5. As used herein, a “pending” I/O transaction is an I/O transaction of which a device assigned to perform, execute, and/or initiate the transaction has been informed, but whose performance, execution, and/or initiation has yet to be completed.

If processor 40 determines that no such pending I/O transactions have been assigned by processor 40, then processor 40 may signal card 20 to signal via bus 22 these one or bus addressable devices. This may result in the disabling of these one or more bus addressable devices from performing further I/O transactions, as illustrated by operation 516 in FIG. 5.

Conversely, if processor 40 determines that one or more of such pending I/O transactions have been assigned by processor 40, processor 40 may signal card 20. As a result of this, card 20 may signal via bus 22 the one or more bus addressable devices that have been assigned such pending I/O transactions that they are enabled to perform such pending I/O transactions. This may enable these one or more bus addressable devices to perform such pending I/O transactions, as illustrated by operation 510 in FIG. 5, and as a result, these one or more bus addressable devices may perform such pending I/O transactions, as illustrated by operation 512 in FIG. 5. Thereafter, processor 40 may signal card 20 to signal via bus 22 these one or bus addressable devices. This may result in the disabling of these one or more bus addressable devices from performing further I/O transactions, as illustrated by operation 516 in FIG. 5.

In accordance with this embodiment, prior to processor 40 signaling card 20 to enable these one or more bus addressable devices to perform such pending I/O transactions, processor 40 may determine whether host processor 12 has changed set of resources that was previously allocated to card 20 by host processor 12, as illustrated by operation 508 in FIG. 5. If processor 40 determines that the host processor 12 has changed the set of resources previously allocated to card 20 by host processor 12, processor 40 may change the respective subsets of resources that processor 40 previously allocated to the bus addressable devices that it determined to be controllable and/or configurable using hardware 24, such that the subsets of resources allocated to these devices are comprised in the set of resources allocated to card 20, as changed by host processor 12. This is illustrated by operation 514 in FIG. 5.

That is, in system 100, subsequent to the allocation by host processor 12 of the set of resources to card 20 in operation 316, host processor 12 may change the set of resources allocated to card 20, including, for example, the set of address resources 402 previously allocated to card 20. This may result from, for example, execution by host processor 12 of operating system and/or other program instructions (not shown) that may result in host processor 12 changing its previous mapping of resources, including resources 400, to devices, such as, for example, card 20 in system 100. For example, a change in the set of resources allocated to card 20 by host processor 12 may include a changed memory mapped I/O space. This changed memory mapped I/O space may be sufficiently different from the memory mapped I/O space previously allocated to card 20 by processor 12 that one or more addresses in address space 406 may not be comprised in the changed memory mapped I/O space.

In system 100, when host processor 12 changes the memory mapped I/O space allocated to card 20, host processor 12 may signal I/O processor 40 via bus 22 to inform I/O processor 40 of same. This may result in I/O processor 40 storing in one or more memory locations 48 one or more values that may specify and/or indicate a mapping of a portion (equal in size to address space 404 in FIG. 4) of the addresses in this changed memory mapped I/O address space to I/O ports and/or memory locations 52. Prior to storing these one or more values in one or more memory locations 48, processor 40 may signal card 20 to store in memory 38 the one or more values previously stored in one or more memory locations 48. When this occurs, processor 40 may compare these values stored in memory 38 and one more memory locations 48, and may determine, based at least in part upon the comparison, whether processor 12 has changed the memory mapped I/O address space 402 that processor 12 previously allocated to card 20. If processor 40 determines that processor 12 has changed the memory mapped I/O address space previously allocated to card 20, this may result in I/O processor 40 changing its previous allocation of memory mapped I/O addresses to I/O ports and/or memory locations in the bus addressable devices that processor 40 determined to be controllable and/or configurable by processor 40 using hardware 24, as illustrated by operation 514 in FIG. 5. More specifically, this may result in I/O processor 40 dividing the remainder of the changed memory mapped I/O address space allocated to card 20 into respective subsets (equal in respective sizes to those allocated in operation 318 in FIG. 3 from space 406 in FIG. 4) allocated to I/O ports and/or memory locations in such bus addressable devices. This ensures that the memory mapped I/O addresses allocated to I/O ports and/or memory locations in such bus addressable devices is comprised within the changed memory mapped I/O address space allocated to card 20. Processor 40 may also store in one or more memory locations 48 one or more values that may specify and/or indicate mappings of the addresses in these respective subsets to I/O ports and/or memory locations in these bus addressable devices. Thereafter, processor 40 may transmit, via bus 22, to these bus addressable devices the mappings of the addresses in these respective subsets to the I/O ports and/or memory locations of these devices. In response, these bus addressable devices may assign memory mapped I/O addresses to their I/O ports and/or memory locations in accordance with these mappings.

For example, in system 100, in operation 504, processor 40 may disable card 20 from signaling controller 26 via bus 22 to perform internally generated I/O requests. Thereafter, processor 40 may determine whether any pending I/O transactions have been assigned to controller 26, as illustrated by operation 506 in FIG. 5. If processor 40 determines that no such pending I/O transactions have been assigned to controller 26, processor 40 may signal card 20 to disable controller 26 from performing further I/O transactions, as illustrated by operation 508 in FIG. 5. Conversely, if processor 40 determines that one or more pending I/O transactions have been assigned to controller 26, processor 40 may determine, for example, in the manner described previously, whether the set of resources previously allocated to card 20 has been changed by processor 12. If processor 40 determines that this set of resources has changed, processor 40 may signal card 20 to change, in the manner described previously, the allocation of resources that it previously made to controller 26, ill Such a way as to ensure that the resources that processor 40 allocates to controller 26 are comprised in the changed set of resources allocated to card 20 by host processor 12. For example, if the changed set of resources allocated to card 20 by host processor 12 includes a changed memory mapped I/O address space, processor 40 may signal card 20 to change the allocation of memory mapped I/O addresses that it previously made to controller 26 so as to ensure that the memory mapped I/O address space allocated to the controller's I/O ports and/or memory locations by processor 40 has the same size as address space 406, and is comprised in the changed memory mapped I/O address space allocated to card 20. In this embodiment, processor 40 may compute a beginning address for its changed allocated of memory mapped I/O addresses to controller 26 by summing together a predetermined offset value and the beginning address of the changed memory mapped I/O address space allocated to card 20.

After operation 516, processor 40 may determine whether it is appropriate for card 20 to transition from its first mode of operation to a second mode of operation, as illustrated by operation 518 in FIG. 5. Processor 40 may determine this based, at least in part, upon whether one or more predetermined events have occurred in system 100 that may indicate that the allocation of resources by host processor 12 in system 100 has stabilized (e.g., after it is unlikely that processor 12 will change further its allocation of resources of system 100 unless and/or until a subsequent event, such as, for example, a subsequent resetting of system 100, occurs). These one or more predetermined events may comprise, for example, registration and/or loading in system memory 21 of one or more driver processes that may be used by host processor 12 to enable host processor 12 to perform one or more I/O transactions involving and/or using card 20. Processor 40 may signal card 20 to scan memory 21 to determine if one or more such driver processes have been registered and/or loaded in memory 21, and if such has occurred, card 20 may signal processor 40. This may result in processor 40 determining that it is appropriate for card 20 to transition and/or enter a second mode of operation. Conversely, if card 20 does not signal processor 40 that one or more such driver processes have not been registered and/or loaded in memory 21, processor 40 may determine that is not appropriate for card 20 to transition and/or enter the second mode of operation. Processor 40 then may continue its processing with the performance of operation 506.

If processor 40 determines that it is appropriate for card 20 to enter the second mode of operation, processor 40 may determine whether the set of resources previously allocated to card 20 by processor 12 has been changed by processor 12, as illustrated by operation 520 in FIG. 5. Processor 40 may make this determination based, at least in part, upon substantially the same considerations, described previously, that it may have used in carrying out operation 508. If, in performing operation 520, processor 40 determines that the host processor 12 has changed the set of resources previously allocated to card 20 by host processor 12, processor 40 may change the respective subsets of resources that processor 40 previously allocated to the bus addressable devices that it determined to be controllable and/or configurable using hardware 24, as illustrated by operation 521 in FIG. 5. The operations that may be performed by processor 40 to carry out operation 521 may be substantially the same as the operations, described previously, that may be performed by processor 40 to carry out operation 514.

After processor 40 either has determined, as a result of operation 520, that the set of resources previously allocated to it has not changed, or alternatively, has determined that this set of resources has changed and has performed operation 521, processor 40 may signal card 20. As a result of this, card 20 may signal via bus 22 the one or more bus addressable devices that processor 40 determined to be controllable and/or configurable by processor 40 using hardware 24. This may result in these bus addressable devices being enabled to perform I/O transactions, as illustrated by operation 522 in FIG. 5. Processor 40 then may signal card 20 to enable the write-back cache memory comprised in memory 38, as illustrated by operation 524 in FIG. 5. After completing operation 524, processor 40 may enable card 20 to signal such bus addressable devices to perform internally generated I/O requests. Thereafter, processor 40 may signal card 20 to enter and/or operate in a second mode of operation in which I/O transactions among processor 40, the write-back cache memory in memory 38, and such bus addressable devices may be enabled.

Although not shown in the Figures, card 20 may include additional circuitry that may facilitate or permit card 20 to carry out the operations described herein and/or additional operations. For example, such additional circuitry in card 20 may include logic that prevents assertion of the TMS signal by card 20 unless the PCIGNT signal (not shown) of bus 22 is also asserted. This may permit card 20 to undertake and/or continue operations directed to discovery and/or configuration of bus addressable devices, such as, for example, controller 26, that may be controllable and/or configurable by processor 40 using hardware 24, after card 20 has ceased issuing retries to processor 12 and/or prior to card 20 issuing such retries to processor 12.

System 100 has been described as comprising a single bus addressable device, such as, controller 26, that may be controlled and/or configured by card 20 using hardware 24. However, system 100 may include a plurality of bus addressable devices that may be controllable and/or configurable by card 20 using hardware 24.

Thus, in summary, in one embodiment of the claimed subject matter, a circuit card is provided that includes a connector that may be used to couple the card to a bus in a motherboard. The motherboard also may include a host processor, MROMB motherboard hardware, and at least one bus addressable device coupled to the bus. When the card is coupled to the bus, circuitry in the card may also be coupled to the bus, and may control and/or configure the at least one bus addressable device using the MROMB motherboard hardware. The circuitry may include an I/O processor and associated firmware memory. When the circuitry in the card is coupled to the bus, the I/O processor in the circuitry may be capable of being allocated a set of resources by the host processor. The circuitry may allocate to the at least one device at least one subset of this set of resources. If the set of resources is changed, the circuitry in the card is also able to change the at least one subset so that the at least subset of resources, as changed, may be comprised in the set of resources, as changed. Advantageously, these features of this embodiment of the present invention may reduce the possibility that a conflict may arise between one or more resources, such as memory mapped I/O addresses, allocated by the host processor and one or more resources allocated by the circuitry in the card to the at least one bus addressable device.

The terms and expressions which have been employed herein are used as terms of description and not of limitation, and there is no intention, in the use of such terms and expressions, of excluding any equivalents of the features shown and described (or portions thereof, and it is recognized that various modifications are possible within the scope of the claims. Accordingly, the claims are intended to cover all such equivalents.

What is claimed is:

1. A method comprising:
allocating a first set of resources to a first device;
allocating, by the first device, a second set of resources to a second device, the first set of resources comprising the second set of resources; and
if the first set of resources is changed, changing, by the first device, the second set of resources.

2. The method of claim 1, wherein:
the first set of resources comprises an address space; and
the second set of resources comprises another address space.

3. The method of claim I, further comprising:
if the first set of resources is changed, and the first set of resources, as changed, no longer comprises the a second set of resources, changing the second set of resources to be comprised in the first set of resources, as changed.

4. The method of claim 1, further comprising:
requesting, by the first device, an amount of resources comprised in the first set of resources from a third device.

5. A method comprising:
enabling, by a first device, a second device to perform one or more pending operations; and
prior to the enabling of the second device to perform the one or more pending operations, determining, by the first device, whether a change has occurred to a first set of resources associated with the first device, the second device being associated with a second set of resources comprised in the first set of resources.

6. The method of claim 5, further comprising:
if the first device determines that the first set of resources has changed, changing, by the first device, the second set of resources associated with the second device.

7. The method of claim 5, further comprising:
after the second device has performed the one or more pending operations, disabling, by the first device, the second device from performing an additional operation; and
if a predetermined event occurs, enabling the second device to perform the additional operation.

8. An apparatus comprising:
a first device to be allocated a first set of resources, to allocate to a second device a second set of resources comprised in the first set of resources, and to change the second set of resources if the first set of resources is changed.

9. The apparatus of claim 8, wherein:
the first set of resources comprises one address space; and
the second set of resources comprises another address space.

10. The apparatus of claim 8, wherein:
if the first set of resources is changed, and the first set of resources, as changed, no longer comprises the second set of resources, the first device is also to change the second set of resources to be comprised in the first set of resources, as changed.

11. The apparatus of claim 8, wherein:
the first device is also to request from the third device an amount of resources comprised in the first set of resources.

12. An apparatus comprising:
a first device to be associated with a first set of resources, to enable a second device to perform one or more pending operations, and to determine, prior to enabling the second device to perform the one or more pending operations, whether a change has occurred to the first set of resources, the second device being associated with a second set of resources comprised in the first set of resources.

13. The apparatus of claim 12, wherein:
if the first device determines that the change has occurred to the first set of resources, the first device is capable of changing the second set of resources associated with the second device, prior to the enabling the second device to perform the one or more pending operations.

14. The apparatus of claim 12, wherein:
after the second device has performed the one or more pending operations, the first device is also capable of disabling the second device from performing an additional operation; and
if a predetermined event occurs, the first device is also capable enabling the second device to perform the additional operation.

15. An article comprising:
a storage medium having stored thereon instructions that when executed by a machine result in the following:
allocating, by a first device, a first set of resources to a second device, the first set of resources being a subset of a second set of resources allocated to the first device; and
if the second set of resources is changed, changing, by the first device, the first set of resources.

16. The article of claim 15, wherein:
the first set of resources comprises one address space; and
the second set of resources comprises another address space.

17. The article of claim 15, wherein the instructions, when executed, also result in:
if the second set of resources is changed, and the second set of resources, as changed, no longer comprises the first set of resources, changing of the first set of resources to be comprised in the second set of resources, as changed.

18. The article of claim 15, wherein the instructions, when executed, also result in:
requesting, by the first device, of an amount of resources comprised in the second set of resources from a third device.

19. An article comprising:
a storage medium having stored thereon instructions that when executed by a machine result in the following:
enabling, by a first device, of a second device to perform one or more pending operations; and
prior to the enabling of the second device to perform the one or more pending operations, determining, by the first device, whether a change has occurred to a first set of resources associated with the first device, the second device being associated with a second set of resources comprised in the first set of resources.

20. The article of claim 19, wherein the instructions, when executed, also result in:
if the first device determines that the first set of resources has changed, changing, by the first device, of the second set of resources associated with the second device.

21. The article of claim 19, wherein the instructions, when executed, also result in:
after the second device has performed the one or more pending operations, disabling, by the first device, of the second device from performing an additional operation; and
if a predetermined event occurs, enabling, by the first device, of the second device to perform the additional operation.

22. A system comprising:
a bus;
at least one device coupled to the bus; and
circuitry that is capable of being coupled to the bus, and when the circuitry is coupled to the bus, the circuitry is also capable of being allocated a set of resources, of allocating to the at least one device at least one subset of the set of resources, and, if the set of resources is changed, of changing the at least one subset.

23. The system of claim 22, further comprising:
a circuit board that comprises the bus and the at least one device; and
a circuit card that comprises the circuitry.

24. The system of claim 22, wherein:
the at least one device comprises at least one of a data storage controller, a network data communication controller, and a server management controller; and
the circuitry comprises an input/output (I/O) processor.

25. A system comprising:
a bus;
at least one device coupled to the bus; and
circuitry that is capable of being coupled to the bus, and when the circuitry is coupled to the bus, the circuitry is also capable of:
enabling the at least one device to perform one or more pending operations; and
prior to the enabling of the at least one device to perform the one or more pending operations, determining whether a change has occurred to a set of resources associated with the circuitry, the at least one device being associated with at least one subset of the set of resources.

26. The system of claim 25, wherein:
the set of resources comprises an address space allocated to the circuitry by a processor.

27. The system of claim 25, wherein:
the at least one subset comprises at least one address space allocated to the at least one device by the circuitry; and
the at least one device comprises memory to store information that specifies the at least one address space.

28. The system of claim 25, wherein:
the system further comprises a processor that is coupled to the bus; and
when the circuitry is coupled to the bus, the circuitry is also capable of issuing to a resource allocation request to the processor, the request being based, at least in part, upon an amount of resources determined to be allocated to the at least one device by the circuitry.

29. The system of claim 25, further comprising:
a circuit board comprising the bus, the at least one device, and a modular redundant array of inexpensive disks (RAID) on motherboard (MROMB) mechanism; and
the circuitry comprises a processor to control the mechanism, at least in part.

30. The system of claim 25, wherein:
the system further comprises a processor that is capable of changing the set of resources;
the circuitry includes memory to store information that specifies, at least in part, the set of resources; and
when the circuitry is coupled to the bus, if the processor changes the set of resources, the circuitry is also capable of determining, based at least in part upon the information, that the set of resources has been changed.
